(19) United States
(12) Patent Application Publication
(10) Pub. No.: US 2023/0088451 A1
(43) Pub. Date: Mar. 23, 2023

(54) BATTERY PACK AND MANUFACTURING METHOD OF BATTERY PACK

(71) Applicant: TOYOTA JIDOSHA KABUSHIKI KAISHA, Toyota-shi Aichi-ken (JP)

(72) Inventors: Nobuyuki Yamazaki, Okazaki-shi Aichi-ken (JP); Yoshinori Shibata, Nagoya-shi Aichi-ken (JP)

(73) Assignee: TOYOTA JIDOSHA KABUSHIKI KAISHA, Toyota-shi Aichi-ken (JP)

(21) Appl. No.: 17/893,831

(22) Filed: Aug. 23, 2022

(30) Foreign Application Priority Data
Sep. 21, 2021 (JP) 2021-153408

(51) Int. Cl. H01M 50/507; H01M 50/204; H01M 50/249; H01M 50/516

(52) U.S. Cl. CPC H01M 50/507; H01M 50/204; H01M 50/249; H01M 50/516; H01M 2220/20

(57) ABSTRACT

A battery pack includes a battery stack composed of a stack of multiple battery cells and a bus bar module fixed to the battery stack. Electrodes are provided on a specific surface of each of the battery cells. The battery stack has a surface composed of the specific surface of each of the multiple battery cells. The bus bar module includes a base member and a bus bar. The base member is fixed on the surface of the battery stack. The bus bar includes a fixed portion fixed to the base member and a first extending portion extending from the fixed portion to a first electrode of the electrodes of each of the multiple battery cells. The first extending portion is welded to the first electrode in a state where stress is applied to the first extending portion in a direction away from the first electrode.

### CROSS-REFERENCE TO RELATED APPLICATION

This application claims priority to Japanese Patent Application No. 2021-153408 filed on Sep. 21, 2021, incorporated herein by reference in its entirety.

### BACKGROUND

### 1. Technical Field

A technique disclosed in the present specification relates to a battery pack and a manufacturing method of the battery pack.

### 2. Description of Related Art

The battery pack disclosed in Japanese Unexamined Patent Application Publication No. 2019-008876 (JP 2019-008876 A) includes a battery stack and a bus bar module. The battery stack is composed of a stack of multiple battery cells. Electrodes are provided on the surface of each battery cell. The bus bar module is fixed on the surface of the battery stack composed of the surface of each battery cell (that is, the surface on which the electrodes are provided). The bus bar module includes a bus bar welded to the electrodes of the battery cell.

### SUMMARY

A welding defect may occur in a case where a welding condition for when the bus bar is welded to the electrodes of the battery cell is not appropriate. For example, when there is a gap between the bus bar and the electrodes in a welding process, the welding defect may occur. In order to detect the welding defect, it is possible to perform an electrical inspection for detecting whether the bus bar and the electrodes are conducting after the welding process. When the bus bar is not in contact with the electrodes due to the welding defect, an abnormality is detected in the electrical inspection. However, although the bus bar is not welded to the electrodes due to the welding defect, the bus bar may be in contact with the electrodes. In this case, since the bus bar is conducting with the electrodes, no abnormality is detected in the electrical inspection. As described above, in the conventional battery pack, it may be difficult to detect the welding defect of the bus bar with respect to the electrodes. This specification proposes a technique for detecting the welding defect of the bus bar with respect to the electrodes more reliably.

A battery pack disclosed in the present specification includes a battery stack composed of a stack of multiple battery cells, and a bus bar module fixed to the battery stack. Electrodes are provided on a specific surface of each of the battery cells. The battery stack has a surface composed of the specific surface of each of the multiple battery cells. The bus bar module includes a base member and a bus bar. The base member is fixed on the surface of the battery stack. The bus bar includes a fixed portion fixed to the base member and a first extending portion extending from the fixed portion to a first electrode of the electrodes of each of the multiple battery cells. The first extending portion is welded to the first electrode in a state where stress is applied to the first extending portion in a direction away from the first electrode.

In this battery pack, the first extending portion is welded to the first electrode in a state where the stress is applied to the first extending portion in the direction away from the first electrode. Therefore, when the first extending portion is welded to the first electrode, and a welding defect occurs, the first extending portion is not in contact with the first electrode. As a result, whether the first extending portion and the first electrode are conducting is electrically detected, so that the welding defect can be detected.

A manufacturing method of a battery pack disclosed in the present specification includes a process of fixing a bus bar module to a battery stack. The battery stack is composed of a stack of multiple battery cells. Electrodes are provided on a specific surface of each of the battery cells. The battery stack has a surface composed of the specific surface of each of the multiple battery cells. The bus bar module includes a base member and a bus bar. The bus bar includes a fixed portion fixed to the base member and a first extending portion extending from the fixed portion. The process of fixing the bus bar module to the battery stack includes a first process and a second process. In the first process, the base member is fixed on the surface of the battery stack such that the first extending portion faces a first electrode of the electrodes of each of the multiple battery cells to be spaced away from the first electrode. In the second process, the first extending portion is welded to the first electrode in a state where the first extending portion is elastically deformed to be in contact with the first electrode.

In this manufacturing method, in the second process, the first extending portion is welded to the first electrode in a state where the first extending portion is elastically deformed to be in contact with the first electrode. Therefore, when a welding defect occurs in the second process, the first extending portion moves to a position where the first extending portion is not in contact with the first electrode due to reaction force caused by elastic deformation after the welding process. As a result, whether the first extending portion and the first electrode are conducting is electrically detected, so that the welding defect can be detected.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery pack;

FIG. 2 is an exploded perspective view of the battery pack;

FIG. 3 is a perspective view of a bus bar;

FIG. 4 is a sectional view of the battery pack taken along the line IV-IV shown in FIG. 3;

FIG. 5 is a sectional view of the battery pack taken along the line V-V shown in FIG. 3;

FIG. 6 is a plan view of the bus bar (view in which a base member is not shown);

FIG. 7 is a sectional view corresponding to FIGS. 4 and 5 of the bus bar before a welding process; and

FIG. 8 is a sectional view corresponding to FIGS. 4 and 5 of the bus bar during the welding process.

### DETAILED DESCRIPTION OF EMBODIMENTS

In a battery pack shown as an example disclosed in the present specification, the first extending portion may include a welded portion welded to the first electrode and a connecting portion connecting the welded portion and the fixed portion. The welded portion may be welded to the first electrode in a state where the connecting portion is elastically deformed such that the welded portion approaches the first electrode.

According to this configuration, when a welding defect occurs, the welded portion is not in contact with the first electrode due to reaction force of the connecting portion. Therefore, the welding defect can be detected.

In a battery pack shown as an example disclosed in the present specification, a height from the surface of the battery stack to the fixed portion may be higher than the height from the surface of the battery stack to the welded portion.

In a battery pack shown as an example disclosed in the present specification, the bus bar may include a second extending portion extending from the fixed portion to an area above a second electrode of the electrodes of the multiple battery cells. The second extending portion may be welded to the second electrode in a state where stress is applied to the second extending portion in a direction away from the second electrode.

In a manufacturing method of a battery pack shown as an example disclosed in the present specification, the first extending portion may include a welded portion welded to the first electrode and a connecting portion connecting the welded portion and the fixed portion. In the second process, the welded portion may be welded to the first electrode in a state where the connecting portion is elastically deformed such that the welded portion approaches the first electrode.

According to this configuration, when a welding defect occurs, the welded portion is not in contact with the first electrode due to reaction force of the connecting portion. Therefore, the welding defect can be detected.

In a manufacturing method of a battery pack shown as an example disclosed in the present specification, the first electrode may be an output electrode of each of the battery cells. The manufacturing method may further include a process of detecting potential of the bus bar after the second process.

According to this configuration, the welding defect can be detected by the potential of the bus bar.

In a manufacturing method of a battery pack shown as an example disclosed in the present specification, the bus bar may include a second extending portion extending from the fixed portion. In the first process, the base member may be fixed on the surface of the battery stack such that the second extending portion faces a second electrode of the electrodes of the multiple battery cells to be spaced away from the second electrode. In the second process, the second extending portion may be welded to the second electrode in a state where the second extending portion is elastically deformed to be in contact with the second electrode.

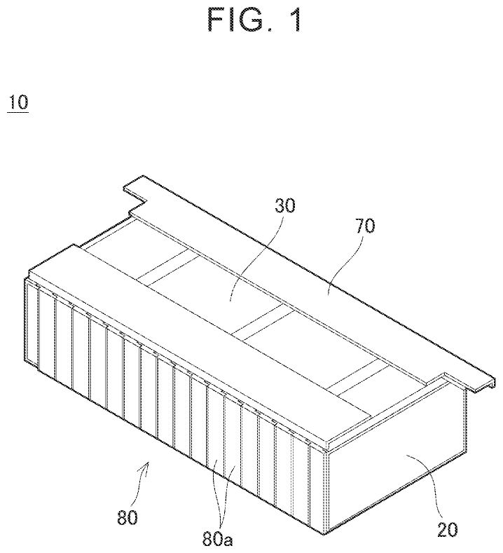

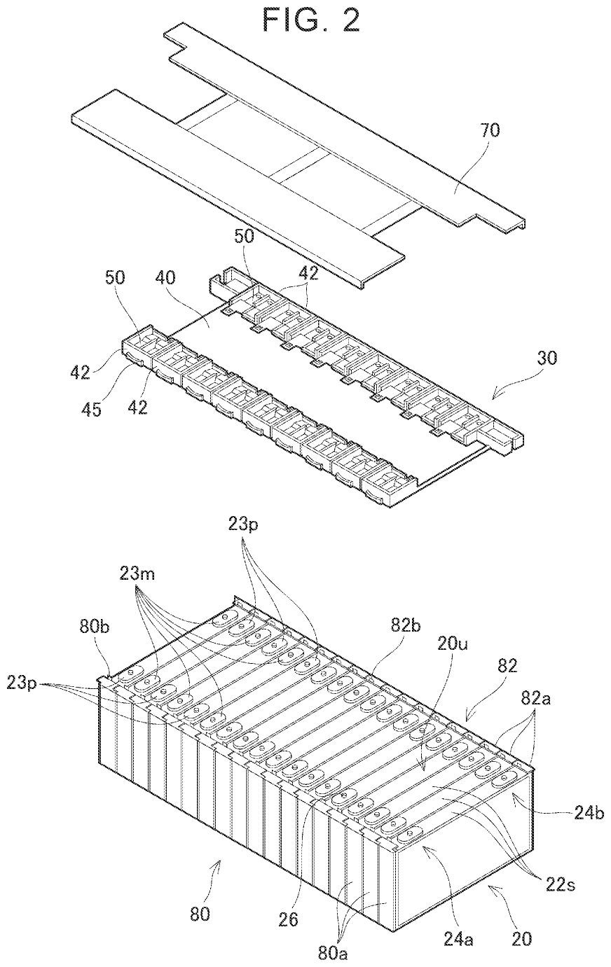

A battery pack 10 according to the embodiment shown in FIG. 1 is mounted on an electrified vehicle. The battery pack 10 supplies electric power to a traction motor of the electrified vehicle. As shown in FIGS. 1 and 2, the battery pack 10 includes a battery stack 20, a bus bar module 30, a cover 70, and resin frames 80 and 82.

As shown in FIG. 2, the battery stack 20 is composed of multiple battery cells 22. Each battery cell 22 has a flat rectangular parallelepiped shape. The battery stack 20 is composed of the multiple battery cells 22 stacked in a thickness direction thereof. Each battery cell 22 has a surface 22s provided with a positive electrode 23p and a negative electrode 23m. The surface 22s of each battery cell 22 constitutes an upper surface 20u of the battery stack 20. In each battery cell 22, the positive electrode 23p and the negative electrode 23m are arranged at opposite ends of the surface 22s. On the upper surface 20u of the battery stack 20, rows 24a and 24b extending along a stacking direction of the battery stack 20 are provided so as to include the positive electrodes 23p and the negative electrodes 23m. In the row 24a, the positive electrodes 23p and the negative electrodes 23m are alternately arranged along the stacking direction. In the row 24b, the positive electrodes 23p and the negative electrodes 23m are alternately arranged along the stacking direction. Hereinafter, the positive electrode 23p and the negative electrode 23m may be collectively referred to as an electrode 23. A projecting portion 26 is provided in the center of the upper surface of each electrode 23.

The resin frame 80 is fixed to one side surface of the battery stack 20. The resin frame 80 is composed of multiple resin connecting members 80a. Each resin connecting member 80a connects two adjacent battery cells 22. The resin frame 82 is fixed to the other side surface of the battery stack 20. The resin frame 82 is composed of multiple resin connecting members 82a. Each resin connecting member 82a connects two adjacent battery cells 22. The multiple battery cells 22 are fixed to each other by the resin frames 80 and 82.

The bus bar module 30 is fixed on the upper surface 20u of the battery stack 20. The cover 70 is fixed to the bus bar module 30 in a state of covering the upper surface of the bus bar module 30.

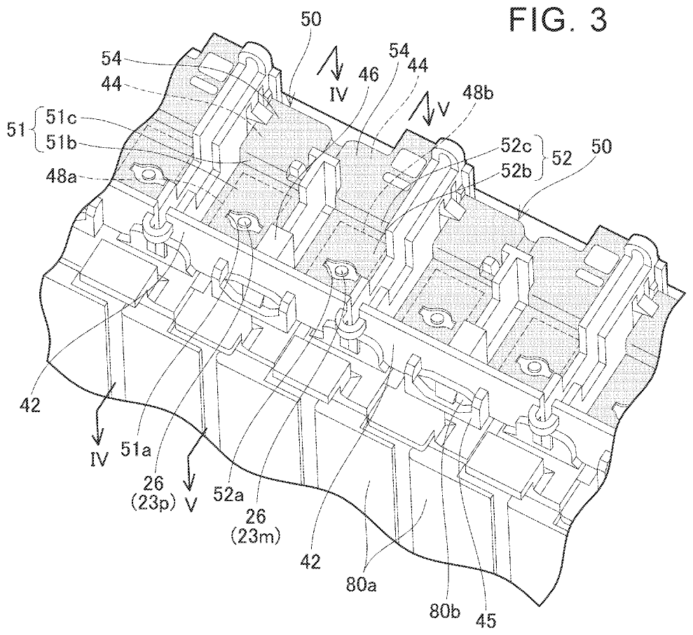

As shown in FIGS. 2 and 3, the bus bar module 30 includes a base member 40 and multiple bus bars 50. In FIG. 3, the bus bar 50 is shown by gray hatching. The base member 40 is composed of an insulating resin. As shown in FIG. 2, the base member 40 includes multiple frame portions 42 provided along both edges of the base member 40. As shown in FIGS. 2 and 3, a clip 45 is provided on the outer side surface of each frame portion 42. A protruding portion 80b is provided on the upper surface of each resin connecting member 80a of the resin frame 80. As shown in FIG. 3, each protruding portion 80b is engaged with each clip 45 of the base member 40. Further, as shown in FIG. 2, a protruding portion 82b is provided on the upper surface of each resin connecting member 82a of the resin frame 82. Although not shown in FIG. 3, each protruding portion 82b is engaged with each clip 45 of the base member 40. The protruding portions 80b and 82b are engaged with the clips 45, so that the base member 40 is fixed to the resin frames 80 and 82. Therefore, the base member 40 is fixed to the battery stack 20 via the resin frames 80 and 82. The base member 40 is fixed on the upper surface 20u of the battery stack 20.

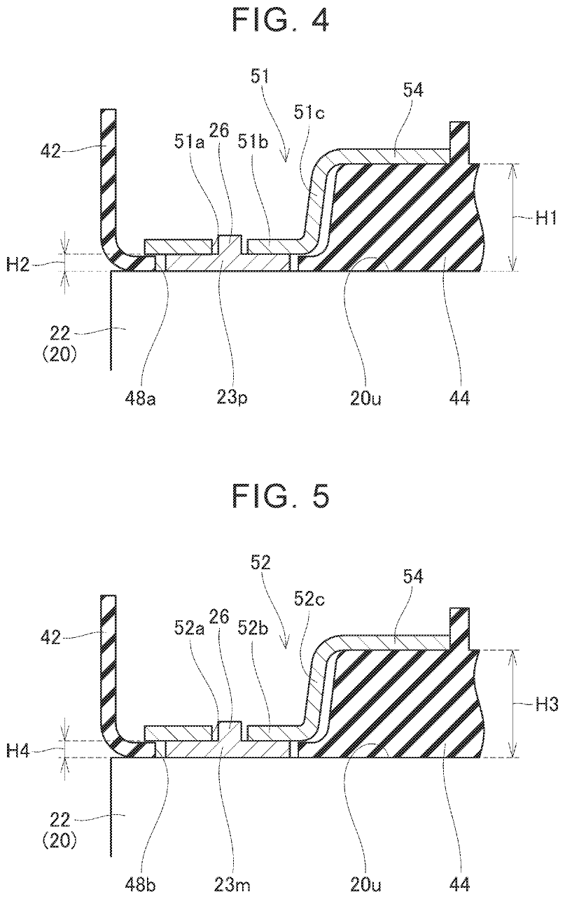

Next, the structure inside each frame portion 42 will be described. FIG. 4 is a sectional view of the battery pack 10 taken along the line IV-IV shown in FIG. 3. As shown in FIG. 4, a support portion 44 is provided in the frame portion 42 of the base member 40. The support portion 44 is fixed on the upper surface 20u of the battery stack 20. An opening 48a is provided at a position adjacent to the support portion 44 in the frame portion 42. Further, FIG. 5 is a sectional view of the battery pack 10 taken along the line V-V shown in FIG. 3. As shown in FIG. 5, the support portion 44 is also provided at the position of the line V-V. Further, an opening 48b is provided at a position adjacent to the support portion 44 in the frame portion 42. As shown in FIG. 3, the opening 48a and the opening 48b are arranged in the frame portion 42 so as to be spaced away from each other. As shown in FIGS. 3 to 5, the positive electrode 23p is disposed in the opening 48a, and the negative electrode 23m is disposed in the opening 48b. As shown in FIG. 3, the opening 48a and the opening 48b are separated by an intermediate partition wall 46.

As shown in FIGS. 2 and 3, each bus bar 50 is disposed in the corresponding frame portion 42. The bus bar 50 is a conductive member made of metal. The bus bar 50 includes a fixed portion 54, a first extending portion 51, and a second extending portion 52. As shown in FIGS. 3 to 5, the fixed portion 54 is fixed on the support portion 44.

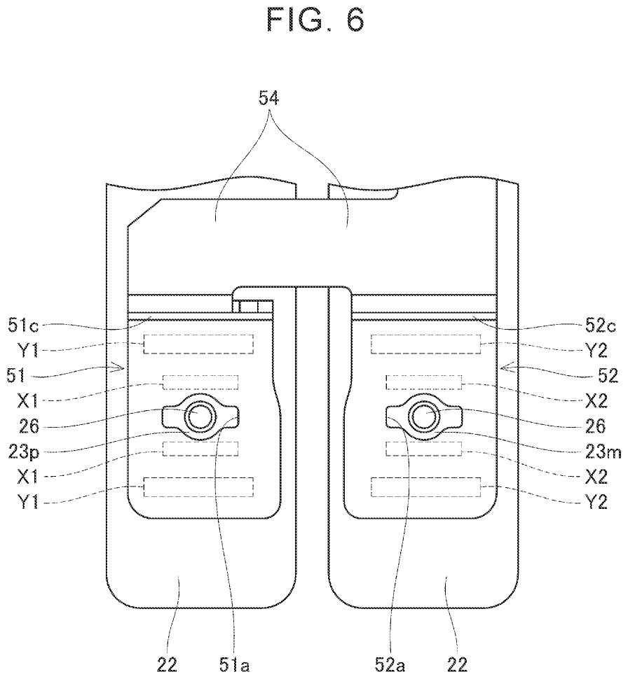

As shown in FIGS. 3 and 4, the first extending portion 51 extends from the fixed portion 54 to the area above the positive electrode 23p in the opening 48a. The first extending portion 51 is provided with a through hole 51a. The first extending portion 51 is welded to the positive electrode 23p in a state where the projecting portion 26 of the positive electrode 23p is inserted into the through hole 51a. Hereinafter, the portion of the first extending portion 51 on the positive electrode 23p is referred to as a welded portion 51b, and the portion connecting the welded portion 51b and the fixed portion 54 is referred to as a connecting portion 51c. As shown in FIG. 6, the welded portion 51b is welded to the positive electrode 23p within a welding range X1 provided on both sides of the through hole 51a. As shown in FIG. 4, the upper surface of the support portion 44 is disposed above the upper surface of the positive electrode 23p. Therefore, a height H1 from the upper surface 20u of the battery stack 20 to the fixed portion 54 is higher than a height H2 from the upper surface 20u to the welded portion 51b. Therefore, the connecting portion 51c extends diagonally downward from the fixed portion 54 toward the welded portion 51b. The connecting portion 51c is elastically deformed such that the welded portion 51b approaches the positive electrode 23p side, and the welded portion 51b is welded to the positive electrode 23p in a state where the connecting portion 51c is elastically deformed as shown in FIG. 4. Therefore, elastic stress is generated in the connecting portion 51c in a direction in which the welded portion 51b is separated from the positive electrode 23p (that is, the upper side).

As shown in FIGS. 3 and 5, the second extending portion 52 extends from the fixed portion 54 to the area above the negative electrode 23m in the opening 48b. The second extending portion 52 is provided with a through hole 52a. The second extending portion 52 is welded to the negative electrode 23m in a state where the projecting portion 26 of the negative electrode 23m is inserted into the through hole 52a. Hereinafter, the portion of the second extending portion 52 on the negative electrode 23m is referred to as a welded portion 52b, and the portion connecting the welded portion 52b and the fixed portion 54 is referred to as a connecting portion 52c. As shown in FIG. 6, the welded portion 52b is welded to the negative electrode 23m within a welding range X2 provided on both sides of the through hole 52a. As shown in FIG. 5, the upper surface of the support portion 44 is disposed above the upper surface of the negative electrode 23m. Therefore, a height H3 from the upper surface 20u of the battery stack 20 to the fixed portion 54 is higher than a height H4 from the upper surface 20u to the welded portion 52b. Therefore, the connecting portion 52c extends diagonally downward from the fixed portion 54 toward the welded portion 52b. The connecting portion 52c is elastically deformed such that the welded portion 52b approaches the negative electrode 23m side, and the welded portion 52b is welded to the negative electrode 23m in a state where the connecting portion 52c is elastically deformed as shown in FIG. 5. Therefore, elastic stress is generated in the connecting portion 52c in a direction in which the welded portion 52b is separated from the negative electrode 23m (that is, the upper side).

As described above, a pair of the positive electrode 23p and negative electrode 23m adjacent to each other is connected by the bus bar 50. As shown in FIG. 2, the bus bars 50 are arranged along the rows 24a and 24b of the electrodes 23. Each pair of the positive electrode 23p and the negative electrode 23m adjacent to each other is connected to each other by each bus bar 50. As a result, each battery cell 22 is connected in series. Therefore, the battery stack 20 outputs a voltage obtained by integrating the output voltages of the battery cells 22.

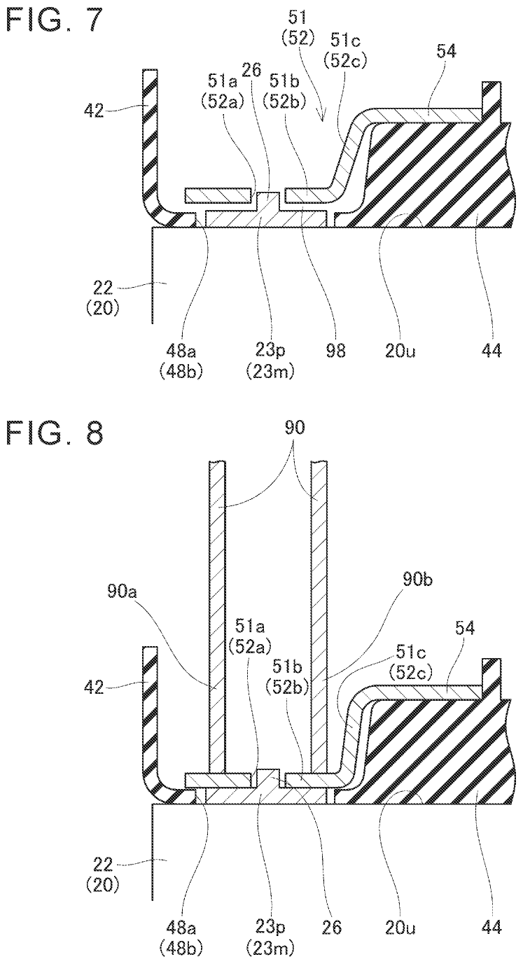

Next, a manufacturing method of the battery pack 10 will be described. First, the battery cells 22 are connected via the resin frames 80 and 82, so that the battery stack 20 is provided. Next, the base member 40 of the bus bar module 30 is fixed to the resin frames 80 and 82. That is, the protruding portions 80b and 82b of the resin frames 80 and 82 are engaged with the clips 45 of the base member 40, so that the base member 40 of the bus bar module 30 is fixed to the resin frames 80 and 82. As a result, the bus bar module 30 is fixed on the upper surface 20u of the battery stack 20. When the bus bar module 30 is fixed on the upper surface 20u of the battery stack 20, as shown in FIG. 7, the first extending portion 51 of each bus bar 50 is disposed above the positive electrode 23p. In this state, there is a gap 98 between the first extending portion 51 and the positive electrode 23p. Further, as shown in FIG. 7, the second extending portion 52 of each bus bar 50 is disposed above the negative electrode 23m in substantially the same manner as the first extending portion 51. In this state, there is a gap 98 between the second extending portion 52 and the negative electrode 23m.

Next, as shown in FIG. 8, the welded portion 51b of the first extending portion 51 is pressurized toward the positive electrode 23p by a pressurizing jig 90. The pressurizing jig 90 has a pair of protrusions 90a and 90b. The protrusions 90a and 90b of the pressurizing jig 90 pressurize the first extending portion 51 toward the positive electrode 23p in ranges Y1 shown in FIG. 6 (that is, the range provided on both sides of the through hole 51a). As a result, the connecting portion 51c is elastically deformed, and the welded portion 51b comes into contact with the positive electrode 23p as shown in FIG. 8. Next, the welded portion 51b (more specifically, the area within the welding ranges X1 in FIG. 6) is irradiated with the laser from above in a state where the first extending portion 51 is pressurized, so that the welded portion 51b is welded to the positive electrode 23p. When the welded portion 51b is welded to the positive electrode 23p as described above, the welded portion 51b is welded to the positive electrode 23p in a state where the connecting portion 51c is elastically deformed. That is, the welded portion 51b is fixed to the positive electrode 23p in a state where stress is generated in the connecting portion 51c in the direction in which the welded portion 51b is separated from the positive electrode 23p.

Further, the second extending portion 52 is welded to the negative electrode 23m in the same manner as in the method in which the first extending portion 51 is welded to the positive electrode 23p. That is, as shown in FIG. 8, the welded portion 52b of the second extending portion 52 is pressurized toward the negative electrode 23m by the pressurizing jig 90. The protrusions 90a and 90b of the pressurizing jig 90 pressurize the second extending portion 52 toward the negative electrode 23m in ranges Y2 shown in FIG. 6 (that is, the range provided on both sides of the through hole 52a). As a result, the connecting portion 52c is elastically deformed, and the welded portion 52b comes into contact with the negative electrode 23m as shown in FIG. 8. Next, the welded portion 52b (more specifically, the area within the welding ranges X2 in FIG. 6) is irradiated with the laser from above in a state where the second extending portion 52 is pressurized, so that the welded portion 52b is welded to the negative electrode 23m. When the welded portion 52b is welded to the negative electrode 23m as described above, the welded portion 52b is welded to the negative electrode 23m in a state where the connecting portion 52c is elastically deformed. That is, the welded portion 52b is fixed to the negative electrode 23m in a state where stress is generated in the connecting portion 52c in the direction in which the welded portion 52b is separated from the negative electrode 23m.

By the welding method described above, each bus bar 50 is welded to the corresponding positive electrode 23p and the negative electrode 23m.

Next, an inspection process of detecting potential of each bus bar 50 is performed. Since the battery stack 20 is a stack of the multiple battery cells 22, a dimensional error due to misalignment of the battery cells 22 while the battery cells 22 are stacked is likely to occur in the battery stack 20. Therefore, the welding condition of each bus bar 50 may not be appropriate due to the dimensional error, and the welding defect may occur. In the manufacturing method described above, there is a gap 98 between the welded portion 51b and the positive electrode 23p before the welded portion 51b is pressurized, as shown in FIG. 7. In the welding process, as shown in FIG. 8, the welded portion 51b is pressurized by the pressurizing jig 90, so that the connecting portion 51c is elastically deformed, and the welded portion 51b comes into contact with the positive electrode 23p. The welded portion 51b is welded to the positive electrode 23p while the connecting portion 51c is elastically deformed as described above. When the welding defect occurs in the welding process, the welded portion 51b is not connected to the positive electrode 23p. In a case where the welding defect occurs as described above, the stress in the connecting portion 51c is released when the pressurizing jig 90 is separated from the welded portion 51b after the welding process, so that the connecting portion 51c returns to the original shape shown in FIG. 7. Therefore, the welded portion 51b is not in contact with the positive electrode 23p. That is, the welded portion 51b is in a state of being insulated from the positive electrode 23p. Therefore, in the subsequent inspection process, the abnormal potential is detected in the bus bar 50 in which the welding defect has occurred. Similarly, even in a case where the welding defect occurs between the welded portion 52b and the negative electrode 23m, the welded portion 52b is not in contact with the negative electrode 23m when the pressurizing jig 90 is separated from the welded portion 52b. Therefore, the abnormal potential is detected in the subsequent inspection process. As described above, in this manufacturing method, the bus bar 50 is not in contact with the electrode 23 when the welding defect occurs, so that the welding defect can be detected by the potential of the bus bar 50. This manufacturing method can detect the welding defect more reliably than the technique in the related art.

In the above embodiment, the bus bar 50 is welded to the electrode 23 by laser welding, but the bus bar 50 may be welded to the electrode 23 by another welding method.

Although the embodiment has been described in detail above, the embodiment is merely an example and does not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or the drawings achieve a plurality of objectives at the same time, and achieving one of the objectives itself has technical usefulness.

What is claimed is:

1. A battery pack comprising:
a battery stack composed of a stack of multiple battery cells; and
a bus bar module fixed to the battery stack, wherein:
electrodes are provided on a specific surface of each of the battery cells;
the battery stack has a surface composed of the specific surface of each of the multiple battery cells; and
the bus bar module includes
a base member fixed on the surface of the battery stack, and
a bus bar including a fixed portion fixed to the base member and a first extending portion extending from the fixed portion to a first electrode of the electrodes of each of the multiple battery cells, wherein the first extending portion is welded to the first electrode in a state where stress is applied to the first extending portion in a direction away from the first electrode.

2. The battery pack according to claim 1, wherein:
the first extending portion includes a welded portion welded to the first electrode and a connecting portion connecting the welded portion and the fixed portion; and
the welded portion is welded to the first electrode in a state where the connecting portion is elastically deformed such that the welded portion approaches the first electrode.

3. The battery pack according to claim 2, wherein a height from the surface of the battery stack to the fixed portion is higher than a height from the surface of the battery stack to the welded portion.

4. The battery pack according to claim 1, wherein:
the bus bar includes a second extending portion extending from the fixed portion to an area above a second electrode of the electrodes of each of the multiple battery cells; and
the second extending portion is welded to the second electrode in a state where stress is applied to the second extending portion in a direction away from the second electrode.

5. A manufacturing method of a battery pack, the manufacturing method comprising a process of fixing a bus bar module to a battery stack, wherein:
the battery stack is composed of a stack of multiple battery cells;
electrodes are provided on a specific surface of each of the battery cells;
the battery stack has a surface composed of the specific surface of each of the multiple battery cells;
the bus bar module includes a base member and a bus bar;
the bus bar includes a fixed portion fixed to the base member and a first extending portion extending from the fixed portion; and
the process of fixing the bus bar module to the battery stack includes
a first process in which the base member is fixed on the surface of the battery stack such that the first extending portion faces a first electrode of the electrodes of each of the multiple battery cells to be spaced away from the first electrode, and
a second process in which the first extending portion is welded to the first electrode in a state where the first extending portion is elastically deformed to be in contact with the first electrode.

6. The manufacturing method according to claim 5, wherein:
the first extending portion includes a welded portion welded to the first electrode and a connecting portion connecting the welded portion and the fixed portion; and
in the second process, the welded portion is welded to the first electrode in a state where the connecting portion is elastically deformed such that the welded portion approaches the first electrode.

7. The manufacturing method according to claim 5, wherein:
the first electrode is an output electrode of each of the battery cells; and
the manufacturing method further includes a process of detecting potential of the bus bar after the second process.

8. The manufacturing method according to claim 5, wherein:
the bus bar includes a second extending portion extending from the fixed portion;
in the first process, the base member is fixed on the surface of the battery stack such that the second extending portion faces a second electrode of the electrodes of each of the multiple battery cells to be spaced away from the second electrode; and
in the second process, the second extending portion is welded to the second electrode in a state where the second extending portion is elastically deformed to be in contact with the second electrode.
